(19) United States
(12) Patent Application Publication
(10) Pub. No.: US 2017/0171066 A1
(43) Pub. Date: Jun. 15, 2017

(54) OPTIMIZING RESTORATION WITH SEGMENT ROUTING

(71) Applicant: ALCATEL-LUCENT USA, INC., Murray Hill, NJ (US)

(72) Inventors: Fang Hao, Morganville, NJ (US); Murali Kodialam, Marlboro, NJ (US); Tirunellai V. Lakshman, Marlboro, NJ (US)

(73) Assignee: ALCATEL-LUCENT USA, INC.

(21) Appl. No.: 14/963,555

(22) Filed: Dec. 9, 2015

(51) Int. Cl. H04L 12/721; H04L 12/729; H04L 12/733

(52) U.S. Cl. CPC H04L 45/44; H04L 45/122; H04L 45/125; H04L 45/127

(57) ABSTRACT

Various exemplary embodiments relate to a routing device used for routing a total amount of traffic, tij from a source node i, to a destination node j, the device including a memory; and a processor configured to: set an amount of traffic in one iteration; find a length for each link e between source node i and destination node j; find a best intermediate node k; and send a flow from source node i, to destination node j through intermediate node k.

### TECHNICAL FIELD

Various exemplary embodiments disclosed herein relate generally to computer networking, and more particularly to internet routing.

### BACKGROUND

Traditional routing in Internet Protocol (IP) networks is often along shortest paths using link weight as the metric. It has been observed that under some traffic conditions, shortest path routing may lead to congestion on some links in the network while capacity may be available elsewhere in the network. Segment Routing is a new Internet Engineering Task Force (IETF) protocol to address this problem. The key idea in segment routing is to break up the routing path into segments in order to enable better network utilization. Segment routing may also enable finer control of the routing paths. It may also be used to route traffic through middle boxes.

### SUMMARY

A brief summary of various exemplary embodiments is presented. Some simplifications and omissions may be made in the following summary, which is intended to highlight and introduce some aspects of the various exemplary embodiments, but not to limit die scope of the invention. Detailed descriptions of a preferred exemplary embodiment adequate to allow those of ordinary skill in the art to make and use the inventive concepts will follow in later sections.

Various exemplary embodiments are described including a method of routing a total amount of traffic, tᵢⱼ from a source node i, to a destination node j, the method including setting an amount of traffic in one iteration; finding a length for each link e between source node i and destination node j; finding a best intermediate node k; and sending a flow from source node i, to destination node j through intermediate node k.

Various exemplary embodiments are described including a routing device used for routing a total amount of traffic, tᵢⱼ from a source node i, to a destination node j, the device including a memory; and a processor configured to: set an amount of traffic in one iteration; find a length for each link e between source node i and destination node j; find a best intermediate node k; and send a flow from source node i, to destination node j through intermediate node k.

### BRIEF DESCRIPTION OF THE DRAWINGS

In order to better understand various exemplary embodiments, reference is made to the accompanying drawings, wherein:

FIG. 1 illustrates a network environment;

FIG. 2 illustrates an embodiment of segment routing;

FIG. 3 illustrates an embodiment of 2-segment routing;

FIG. 4 illustrates an embodiment of segment routing in an SDN;

FIG. 5 illustrates an embodiment of a restoration path;

FIG. 6 illustrates shared restoration bandwidth;

FIG. 7 illustrates an exemplary algorithm for segment routing with restoration; and

FIG. 8 illustrates an embodiment of restoration on node failure.

To facilitate understanding, identical reference numerals have been used to designate elements having substantially the same or similar structure or substantially the same or similar function.

### DETAILED DESCRIPTION

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments.

Segment routing is a new proposed routing mechanism for simplified and flexible path control in IP/MPLS (Multiprotocol Label Switching) networks. Segment routing builds on existing network routing and connection management protocols and one of its important features is the automatic rerouting of connections upon failure. Re-routing can be done with available restoration mechanisms including Interior Gateway Protocol (IGP)-based rerouting and fast reroute with loop-free alternates. This may be particularly attractive for use in Software Defined Networks (SDN) because the central controller may need only be involved at connection set-up time and failures may be handled automatically in a distributed manner. A significant challenge in restoration optimization in segment routed networks is the centralized determination of connections' primary paths so as to enable the best sharing of restoration bandwidth over non-simultaneous network failures. One may formulate this problem as a linear programming problem and develop an efficient primal-dual algorithm for the solution. One may also develop a simple randomized rounding scheme for cases when there are additional constraints on segment routing. One may demonstrate the significant capacity benefits achievable from this optimized restoration with segment routing.

Segment Routing is envisaged to make possible simplified flexible connection routing in IP/MPLS networks building largely on features of existing network protocols. The main idea in segment routing is to use a sequence of segments to compose the desired end-to-end connection path. The path between each segment's end points is determined by a conventional routing protocol like Open Shortest Path First (OSPF). The segment labels are carried in the packet header and so per flow state is maintained only at the ingress node. A segment label is like an MPLS label and traditional push, pop, swap actions can be applied to it by the routers on the segment path. Segment routing permits finer control of the routing paths and so can be used to distribute traffic for better network utilization. A central controller can exploit the full potential of segment routing by choosing segments based on the traffic pattern to judiciously distribute traffic in the network and avoid local hot-spots. This central control element can be done by a path computation element or in the case of a Software Defined Network (SDN) the SDN controller. There has been some recent work on determining the optimal segment routed paths for improving network bandwidth utilization. While the SDN controller can set up the segments based on measured or predicted traffic, it is not necessarily desirable to involve the controller when there are network failures. One of the key features that segment routing offers is that each segment is routed by the IGP routing protocol and the failure recovery mechanisms of the IGP routing protocol can be used to recover from failures in a distributed manner. Thus an SDN controlled segment routed network can combine the efficiency of centralized control with the fast scalable response to failures that a distributed routing mechanism offers. This distributed restoration assumes that there are sufficient resources in the network to route around network failures. An alternative to an SDN controller is a centralized Path Computation Element (PCE) that plays the same role as an SDN controller. The problem that embodiments address include how to configure the initial segments such that there are sufficient network resources available for rerouting traffic when there are network failures. One may first address the most common practical system when routing is on a single shortest path and the network has to recover from single link failures. One may show how to generalize the approach to handle the case where routing is along Equal Cost Multipaths (ECMP) and the network has to recover from Shared Risk Link Group (SRLG) failures where multiple links can fail at the same time. The key to restoration planning is to share the restoration bandwidth efficiently among independent failures. Embodiments include:
Restoration planning in segment routed networks.
Development of a fast Fully Polynomial Time Approximation Scheme (FPTAS) for the restoration planning problem for single link failures.
Fast algorithms for restoration planning with ECMP and SRLG failures.

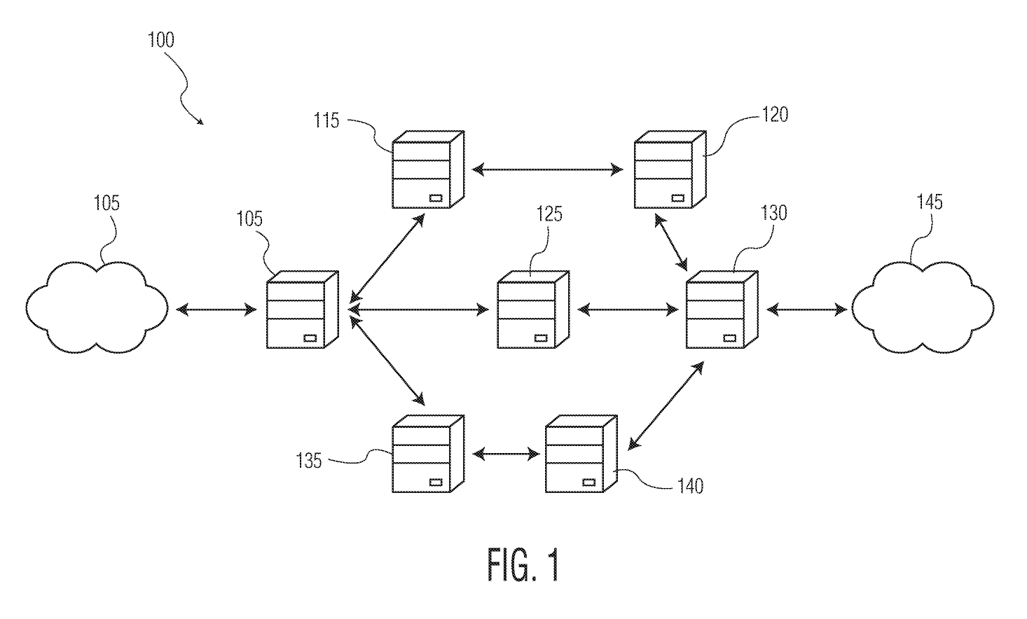

FIG. 1 illustrates an exemplary network environment 100. As shown, the network environment 100 includes networks 105 and 145, connected to network equipment 110, 115, 120, 125, 130, 135, and 140. Network equipment 110, 115, 120, 125, 130, 135, and 140 may be a server, a data center, a blade, a desktop computer, or a node, for example of a data network. Networks 105 and 145 may be any kind of communication networks that are capable of facilitating inter-device communication. In various embodiments, the networks 105, and 145 include an IP/Ethernet network, a telecommunications network such as Public Land Mobile Network (PLMN), or a 3rd Generation Partnership Project protocol, and may include the Internet.

Each of network equipment 105-140 may be connected to an adjacent piece of network equipment 105-140 as pictured. It will be apparent that any configuration of network topology and sequence may be configured including, ring, mesh, star, full connected, bus, tree and line, for example. It will be apparent that fewer or additional pieces of network equipment may exist within exemplary network environment 100. In various exemplary embodiments, network equipment 105-140 may be geographically distributed; for example, network equipment 110, 125, and 130 may be located in Washington, D.C.; Seattle, Wash.; and Tokyo, Japan, respectively. Each piece of network equipment 105-140, may include hardware or software resources for networking including routing capabilities.

Outline of Segment Routing

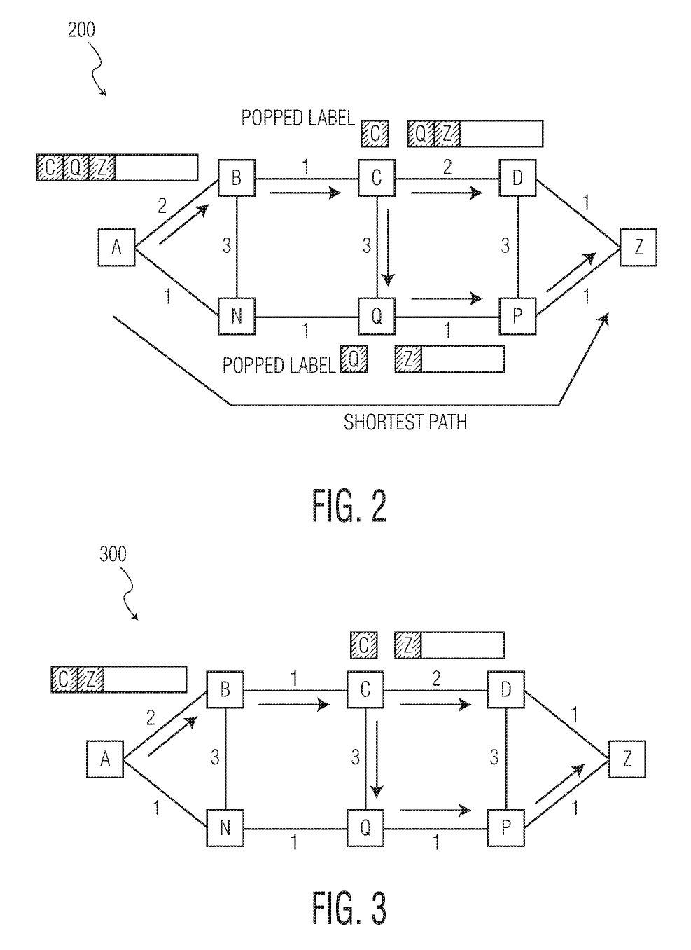

FIG. 2 illustrates an embodiment of segment routing. One key idea in segment routing is to split the routing path into multiple segments. The segment identifiers are coded into the packet header. Routing within each segment is done by the IGP routing protocol. FIG. 2 shows a network with bi-directional links. The number next to each link is its IGP link weight. Consider a connection that has to be established between nodes A and Z. If OSPF is used, packets belonging to this flow will be routed on the shortest path A-N-Q-P-Z. Assume that link N-Q and C-D are congested and one may want to route the packet on the path A-B-C-Q-P-Z. This is done by breaking the path into two segments A-B-C and C-Q-P-Z. In addition to the destination address Z, the segment labels C and Q are added to the header. The packet is routed from A to C along the shortest path A-B-C and at node C, the top label is popped and the packet is now routed to Q. At node Q, the second label is popped the packet is routed to Z along the shortest path. Note that there is no per-flow state at any of the intermediate nodes in the network.

When there are no segment identifiers, then packets are routed along shortest paths as in standard IGP routing protocols. The other extreme is when each hop is specified in the packet header and this resembles explicit path routing. This fine grained control of the routing path enables the easy deployment of network functions like service chaining where the packet has to pass through a set of middle boxes when it goes from the source to destination. Segment routing can also be used for steering traffic to avoid hot spots in the network and hence improve network utilization. There are two basic types of segments: node and adjacency. A node segment identifies a router node. Node segment IDs are globally unique across the domain. An adjacency segment represents a local interface of a node. Adjacency segment IDs are typically only locally significant on each node. The MPLS data plane can be leveraged to implement segment routing essentially without modification since the same label switching mechanism can be used. Segment labels are distributed across the network using simple extensions to current IGP protocols and hence Label Distribution Protocol (LDP) and Resource Reservation Protocol—Traffic Engineering (RSVP-TE) are no longer required for distributing labels. As a result, the control plane can be significantly simplified. Moreover, unlike MPLS, there is no need to maintain path state in segment routing except on the ingress node, because packets are now routed based on the list of segments they carry. The ingress node should be modified since it needs to determine the path and add the segment labels to the packet. For traffic planning problems where the objective is to route traffic so that no link is overloaded, it is generally enough to consider segment routes with just two segments.

FIG. 3 illustrates an embodiment of 2-segment routing 300. In the case of two segment routing, traffic is routed though one intermediate node. In FIG. 3, the path A-B-C-D-Z is represented as two segments, one from A to C and the other from C to Z. 2-segment routing can be implemented with just one extra label and may give excellent performance. Generalization to segments having more than two hops is straightforward and just involves higher computational tunes.

System Model

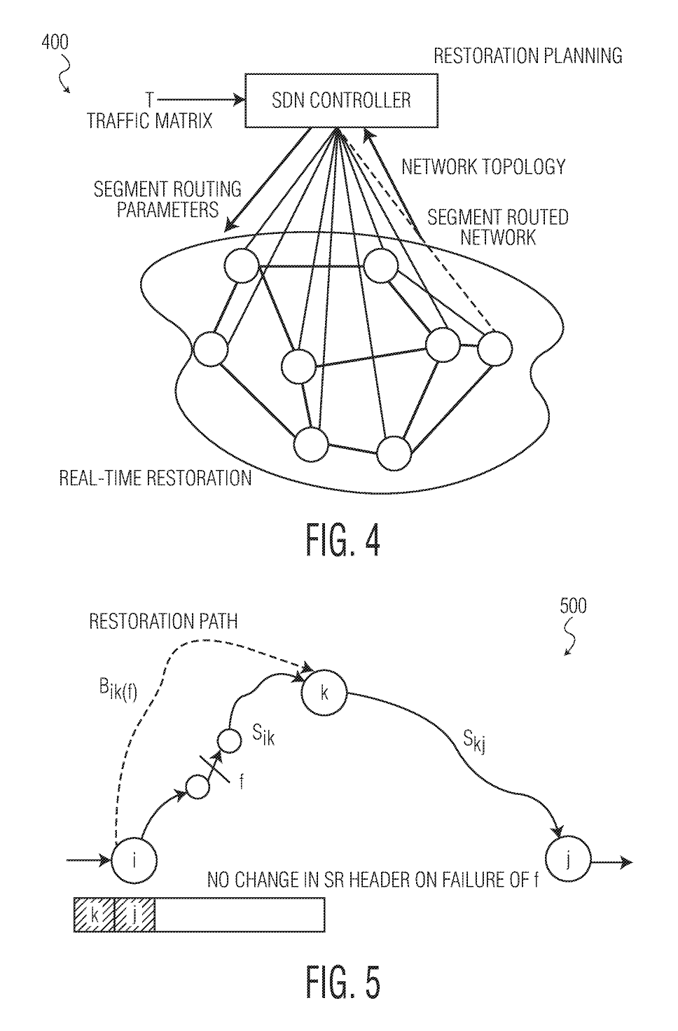

FIG. 4 illustrates an embodiment of segment routing in an SDN 400. One may assume that the segment routed network is controlled by an SDN controller as shown in FIG. 4. The SDN controller has full knowledge of the network topology and may communicate with all the routes in the network. Traffic matrix information may be fed to the SDN controller. Using this traffic matrix and network topology information the SDN controller determines the segment routed paths for each source-destination pair in the network. This information may be fed to the edge routers that are ultimately responsible for pushing the segment labels on the packet header. Once the segments are set up, packets are routed through the network using these segments.

Segment Routing and Restoration

A major advantage that segment routing offers compared to explicit path routing is that when there are failures in the network, the IGP protocol may recompute the shortest path. Therefore the segments are repaired when there are failures in the network without any intervention. This may be useful, even in SDN networks, since the central controller then does not have to reroute the potentially large number of connections that may have to be rerouted with strict time constraints when there are network failures.

Restoration Requirements

Typical failures considered in optical network restoration, IP/MPLS restoration, and optimization include:
Single link failures
Single node failures
Shared Risk Link Group (SRLG) failures

In the case of SRLG failures, multiple links can fail together. SRLG models networks where several logical links share the same physical infrastructure. Since the failure scenarios are independent, in each of these cases, there is potential to share restoration bandwidth among the independent failure scenarios. Single link failures is a scenario of interest in practice and it makes the description of the algorithm simpler. SRLG failures are more complex and subsume node failures.

Mathematical Model

A network may be represented by a graph G=(N,E), where the nodes are the routers connected by directed links. Link e has an IGP link weight w(e) and capacity c(e). One may use n to represent the number of nodes in the network and m to represent the number of links. One may not assume that the network is symmetric. The aggregate amount of traffic between nodes i and j is denoted by tᵢⱼ. Traffic between nodes i and j can be split across multiple paths between i and j. One may assume that this split is flow based. In other words, one may assume that the source node splits the traffic using a hashing scheme that ensures that all packets belonging to the same flow are routed on the same path (thus maintaining packet ordering). One may assume that individual flows are relatively small compared to the total link capacity. This ensures that traffic can be spread arbitrarily between different paths. Assume that the link weights are fixed and all routing is along shortest paths using this link weight as the metric. Let Sᵢⱼ denote the set of links on the shortest path from i to j. Note that when there are multiple shortest paths between nodes, then the network can split traffic across these equal cost paths. Initially, one may assume that there is a unique shortest path between the each pair of nodes. This may be done simply to describe the algorithm. One may show how to extend the restoration algorithm for the case where ECMP is used.

FIG. 5 illustrates an embodiment of a restoration path 500. In FIG. 5 traffic from i to j may be routed along a two segment path i-k and k-j. If link f on the shortest path Sᵢₖ from i to k fails, packets will be routed from i to k along the restoration path Bᵢₖ(f).

Restoration Planning Problem for Single Link Failures

In some embodiments, one may assume that all flows in the network have to be protected against single link failures. All the IGP link weights are assumed to be given. This implies that the shortest path route between any pair of nodes may be fixed. If there are several alternate shortest paths, then one may assume that one of these paths may be used for routing. Additional embodiments consider the case where equal cost multi-path may be used to route packets. One may denote the set of links in the shortest path between nodes i and j as Sᵢⱼ. If some link f∈Sᵢⱼ fails, then the nodes in the network will recompute the shortest path after eliminating link f and packets will be routed along this new shortest path. Let Bᵢⱼ(f) represent the set of links in the shortest path between nodes i and j when link f fails. Note that some of the links in Sᵢⱼ might be contained in Bᵢⱼ(f). One may use Nᵢⱼ(f)=Bᵢⱼ(f)\Sᵢⱼ to denote the set of new links on which there will be (ij) traffic flow when link f fails.

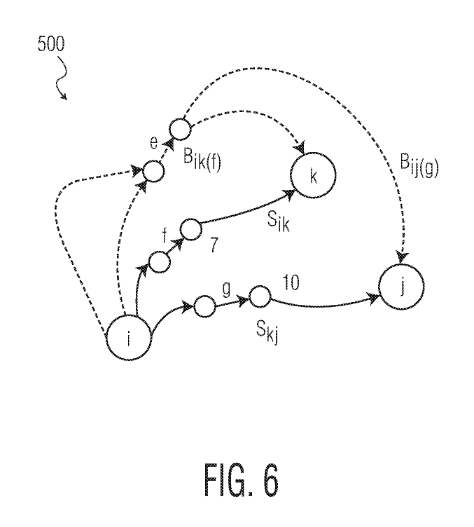

FIG. 6 illustrates shared restoration bandwidth 600. In FIG. 6, Link e∈Bᵢₖ(f)∩Bᵢⱼ(g). The flow on segment i-j may be 10 units and on segment i-k may be 7 units. One may only need to reserve 7 units of restoration bandwidth on link e. FIG. 6 illustrates the shortest path, restoration path, and the set of new links in the restoration path between nodes i and j. One may set Bᵢⱼ(t)=Ø if f∉Sᵢⱼ. Since the IGP weights are known, the set of links Sᵢⱼ and Nᵢⱼ( ) can be precomputed for all pairs of nodes. Since every flow may be 2-segment routed, the decision that the SDN controller has to make for each (ij) flow may be to pick the intermediate node k that splits the path into two segments. If k=i or k-j, then the connection is routed on the shortest path Sᵢⱼ. If k≠i,j, then the flow may be first routed on the shortest path from i to k and then on the shortest path from k to j. The objective of the SDN controller may be to pick these segments, such that there may be sufficient link bandwidth to handle any single link failure. Let xᵢⱼ^{k} denote the amount of traffic between i and j that may be routed through node k. Recall that in 2-segment routing one may just have to pick one intermediate node through which flow may be touted. Intermediate node k=i or k=j represents the shortest path from i to j. Let xᵢⱼ^{k} denote amount of traffic which may be routed from i to j through intermediate node k. One may want to ensure that all the traffic between i and j may be routed through some intermediate node. Therefore, Σₖ xᵢⱼ^{k}=tᵢⱼ ∀i, j.

Computing the Link Load

The traffic on a link can be split into primary traffic and restoration traffic. Primary traffic may be the amount of traffic on die link as a result of routing flows on the link when there are no failures in the network. Restoration traffic may be the traffic that flows on a link due to some failure in the network. Let P(e) denote the primary flow on link e and R(e,f) denote the restoration flow on link e, when link f fails. If link e∈Sᵢₖ or Sₖⱼ, then there will be a traffic of xᵢⱼ^{k} that will flow on link e. Therefore, the total amount of primary traffic P(e) on link e will be

$$P ( e ) = {\sum }_{( ijk ) : e ∈ {S}_{ik} ⋃ {S}_{kj}} {x}_{ij}^{k} .$$

The amount of bandwidth reservation for restoration traffic on link e should equal the maximum amount of flow that can result on link e due to the failure of link f in the network. This may be due to the fact that link failures are independent and one may only need to have enough bandwidth to carry traffic in the worst case. In FIG. 6, note that link e is on the restoration path for the segment i-j that may be carrying 10 units of traffic and segment i-k carrying 7 units. Since there are no common links between these two segments, any single link failure only results in a maximum flow of 10 units and this may be the reservation that one may need to make on e for restoration.

When e∈Nᵢₖ(f)∪Nₖⱼ(f) and link f fails, then there will be a flow of xᵢⱼ^{k} on link e. Note that if e∈Bᵢₖ(f)∩Sᵢₖ or e∈Bₖⱼ(f)∩Sₖⱼ then it is already carrying a flow of xᵢⱼ^{k} that may be routed from i to j through node k (before any failures). Therefore there may not be any additional traffic on link e if link f fails. The amount of restoration traffic R(e,f) on link e if f fails may be given by:

$$R ( e , f ) = {\sum }_{( ijk ) : e ∈ {N}_{ik} ( f ) ⋃ {N}_{kj} ( f )} {x}_{ij}^{k} .$$

Since the link failures are independent, one may need to ensure that R(e)+max_{f}R(e,f)≦C(e) for all links e. The routing objective may be to find a set of segments such that the maximum link load under any failure scenario may be as small as possible. One may formulate the problem of determining xᵢⱼ^{k} such that the maximum link utilization may be minimized. In other words, the objective may be to minimize φ such that P(e)+max_{f}R(e,f)≦φ c(e). Instead of formulating this problem directly, one may introduce a new variable

$$λ = \frac{1}{φ} .$$

Instead of scaling the link capacity, one may instead scale up the traffic by a factor of λ. The inverse of the maximum link utilization may be called the throughput. One objective may be to maximize the throughput λ such that when the traffic matrix may be scaled up by λ the resultant primary and restoration traffic still fits in the network. The resultant maximum link utilization may be 1/λ. This formulation that resembles the maximum concurrent flow problem, permits a simple fully polynomial time approximation scheme. Towards this end, one may write the restoration planning problem for the single link failure may be written as the following linear program:

$$\begin{matrix}max λ & ( 1 ) \\ {\sum }_{( ijk ) : e ∈ {S}_{ik} ⋃ {S}_{kj}} {x}_{ij}^{k} + {\sum }_{( ijk ) : e ∈ {N}_{ik} ( f ) ⋃ {N}_{kj} ( f )} {x}_{ij}^{k} \leq c ( e ) \text{∀} f \text{∀} e & \\ {\sum }_{k} {x}_{ij}^{k} \geq λ {t}_{ij} \text{∀} ( ij ) & ( 2 ) \\ {x}_{ij}^{k} \geq 0 \text{∀} ( ijk ) & \end{matrix}$$

There are O(n³) variables and O(n²+m²) constraints. One may directly solve this linear programming problem. One may develop a simple primal-dual algorithm to solve the problem. One may associate dual variables π(e,f) with the constraint (1) and θᵢⱼ with constraints (2). The dual may be the following linear programming problem:

$$\begin{matrix} min {\sum }_{e} c ( e ) {\sum }_{f} π ( e , f ) & ( 3 ) \\ {\sum }_{e ∈ {S}_{ik}} [ {\sum }_{f} π ( e , f ) + {\sum }_{f ∈ {N}_{ik} ( e )}^{ } π ( f , e ) ] + {\sum }_{e ∈ {S}_{kj}} [ {\sum }_{f} π ( e , f ) + {\sum }_{f ∈ {N}_{kj} ( e )} π ( f , e ) ] \leq {θ}_{ij} \text{∀} k & \\ {\sum }_{ij} {t}_{ij} {θ}_{ij} = 1 & \\ π ( e , f ) \geq 0 \text{∀} e , f & \\ {θ}_{ij} \geq 0 \text{∀} ( ij ) & \end{matrix}$$

Given a pair of nodes i and j and a link e∈Sᵢⱼ, one may define

lᵢⱼ(e)=Σ_{f}π(e,f)+Σ_{f∈N}_{ᵢⱼ}₍ₑ₎π(f,e) (4)

to be the length of link e. The running time for this step for each pair (ij) may be O(m). One may now write constraint (3) as

$${θ}_{ij} \geq {\sum }_{e ∈ {S}_{ik}} {𝓁}_{ik} ( e ) + {\sum }_{e ∈ {S}_{kj}} {𝓁}_{kj} ( e ) .$$

Therefore, for a given source-destination pair (ij), one may set

$${θ}_{ij} = {min}_{k} {\sum }_{e ∈ {S}_{ik}} {𝓁}_{ik} ( e ) + {\sum }_{e ∈ {S}_{kj}} {𝓁}_{kj} ( e ) . \qquad ( 5 )$$

The best intermediate node for source-destination pair (ij) may be the intermediate node k that achieves the minimum value of θᵢⱼ. Finding the best intermediate node for each pair of nodes involves finding the cost of every link on the shortest path. In the worst case the shortest path can have O(n) links, Therefore, to evaluate the cost of picking a particular intermediate node will take O(nm) time and finding the best intermediate node will take O(n²m) time. One may use π to represent the m×m vector π(e,f). One may define D(π)=Σₑ c(e)Σ_{f} π(e,f) and ρ(π)=Σᵢⱼ tᵢⱼθᵢⱼ. Note that θᵢⱼ values are a function of π). The dual problem can now be reformulated as the following:

$${min}_{π \geq 0} \frac{D ( π )}{ρ ( π )} .$$

The primal-dual algorithm for solving this problem may be a Fully Polynomial Time Approximation Scheme (FPTAS). In an FPTAS, one may be given an ∈ and the algorithm finds a solution that may be within (1−∈) of the optimal solution in running time that may be a function of the problem parameters and

$$\frac{1}{ɛ} .$$

The algorithm starts off by initializing

$$π ( e , f ) = \frac{δ}{c ( e )}$$

for all e, f where δ may be a number that may be computed based on ∈ and the network parameters. All flows are initialized to zero. The algorithm works in multiple phases where each phase comprises of one iteration through each source-destination pair (ij) such that tᵢⱼ>0. One may call each of these source destination pairs with non-zero demand a demand pair. In each iteration corresponding to source-destination pair (ij) traffic may be routed from i to j in multiple steps until a total traffic of tᵢⱼ has been routed. In each step the following computations are done:
1. Set the amount of traffic routed in this iteration to t′=tᵢⱼ.
2. Find the length lᵢⱼ(e) for each link e based on the current π(e,f) as shown in Equation (4).
3. Find the best intermediate node k as per Equation (5).
4. Find the minimum capacity link in Sᵢₖ∪Sₖⱼ and set

$$m = {min}_{e ∈ {S}_{ik} ⋃ {S}_{kj}} c ( e ) .$$

5. Send a flow of Δ=min{m,t′} from i to j through k. Set xᵢⱼ^{k}←xᵢⱼ^{k}+Δ.
6. Update die dual values. Let Pᵢⱼ=Sᵢₖ∪Sₖⱼ denote links in the two segments that are used for the routing flow.

$$\begin{matrix}π ( e , f ) ← π ( e , f ) [ 1 + ɛ \frac{Δ}{c ( e )} ] ∀ f ∀ e ∈ {P}_{ij} & \\ π ( f , e ) ← π ( f , e ) [ 1 + ɛ \frac{Δ}{c ( f )} ] ∀ f ∈ {N}_{ij} ( e ) ∀ e ∈ {P}_{ij} & \\ 7. Set {t}^{′} ← {t}^{′} - Δ & \end{matrix}$$

This process of finding the best segments and routing flow may be repeated until the termination condition may be met. The running time for each demand pair may be O(n²m) and there may be up to n² demand pairs, making the running time for each phase O(n⁴m). Note that this may be an over-estimate. The number of demand pairs could be far less than O(n²) and the cost of each step in the algorithm depends on the length of the shortest path between node pairs which may be typically far less than the upper bound of n.

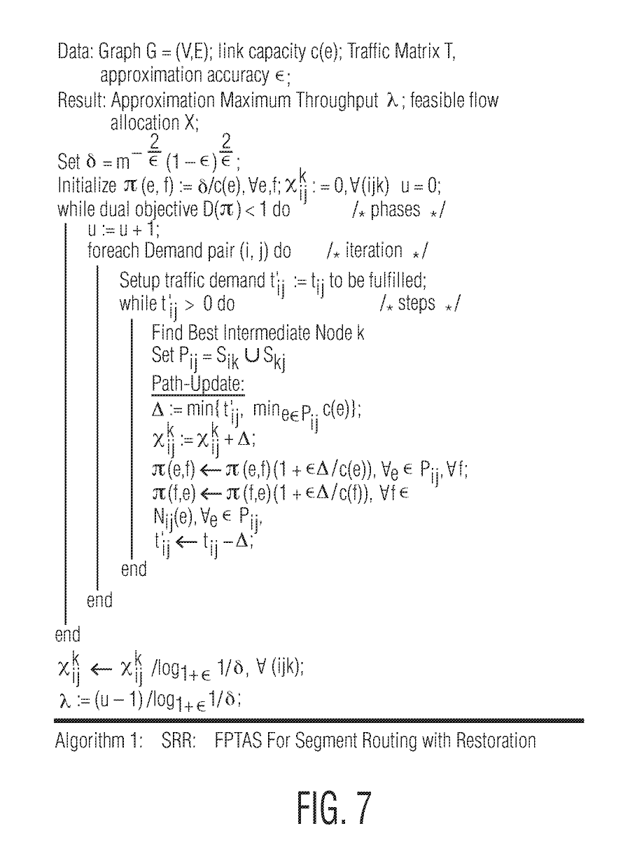

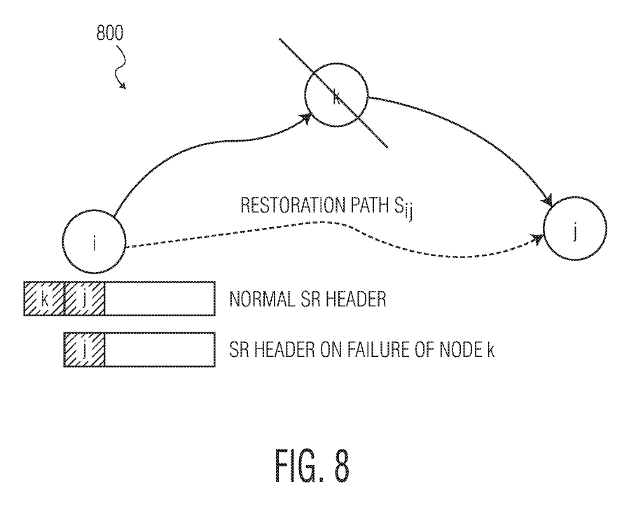

FIG. 7 illustrates an exemplary algorithm for segment routing with restoration 700. FIG. 7 illustrates a more formal presentation of the algorithm, FPTAS For Segment Routing with Restoration. The algorithm may be very simple to implement and has a very good running time even on large networks. Let b be the dual optimal solution. Assume that traffic may be scaled such that b>1. The segment routing with restoration algorithm obtains a (1−∈)⁻³ approximation to the segment routing with restoration problem with running time

$$O ( {n}^{4} m \frac{b}{ɛ} {log}_{1 + ɛ} \frac{m}{1 - ɛ} ) .$$

Handling ECMP and SRLG Failures

The primal dual approach above may be generalized to networks where failures are of a more general nature as well as the case traffic between a source and destination may be split across multiple equal cost paths. In the last section, one may have planned restoration paths in the case where the network has to be resilient to single link failures.

Shared Risk Link Group Failures

In practice, the network may subjected to more serious failures, including node failures. In addition, there can be several links in the network that share physical infrastructure. This results in multiple links failing at the same time when the physical infrastructure fails. The term Shared Risk Link group (SRLG) refers to a set of links that share a risk and can fail at the same time. In the SRLG failure model, each SRLG may be specified as a set of links. A SRLG family may be a collection of subsets of links that can fail at the same time. One may use F to denote a set of links that fail at the same time. One may use F to denote a collection of subset of links. In the case of single link failures, the collection F={{e₁}, {e₂}, . . . , {eₘ}}. Let E(vⱼ) represent the set of links with vⱼ as one of the endpoints. Then node failures can be represented by the collection of sets F={E(v₁), E(v₂), . . . . E(vₙ)}. Unlike link failures where the segment routing headers are unchanged, in the case of node failures (or more generally SRLG failures) SR headers may have to be changed.

FIG. 8, for example, illustrates an embodiment of restoration on node failure 800. FIG. 8 shows the failure of node k that forms the end of an intermediate segment. In this case, one option for the source may be to route the packet directly to the destination j along the shortest paths Sᵢⱼ. Embodiments described may be directly applied to any restoration problem as long as it may be known in advance what path will be taken when there may be any given failure. In segment routed networks, it generally will be shortest path from source to destination when all the failed links are removed from die network. This may involve changing the segment labels when there are failures.

Equal Cost Multi-Paths

A routing feature commonly used in networks to distribute load may be Equal Cost Multi-Path (ECMP) routing. In ECMP routing, traffic is split evenly across all minimum cost paths. The split may be done by hashing on the flow ID of the packet to ensure that packets belonging to the same flow are routed on the same path to avoid packet reordering at the destination. When ECMP may be used, it may be easy to figure out apriori the fraction of traffic between any pair of nodes that will be routed on a given link. This information may be enough for one to formulate the Restoration planning problem in networks using ECMP. Let 0≦(e)≦1 denote the fraction of traffic from i to j that goes through link e. In the case of standard shortest path routing, (e)=1 for all e∈Sᵢⱼ and may be zero otherwise. For any given source-destination pair, it may be easy to compute (e) if the IGP link weights are known. Let (e,F) denote the fraction of the traffic from i to j that goes on link e if there may be a failure F in the network. Note that in the SRLG model, F can be multiple links. The primary flow P(e) on link e is

$$P ( e ) = {\sum }_{( ijk )} [ ( e ) + ( e ) ] {x}_{ij}^{k} .$$

When there is a failure F in the network, the amount of excess flow Δᵢⱼ(e,F) on link e for flows between i and j may be given by:

Δᵢⱼ(e,F)=[(e,F)−(e)]⁺xᵢⱼ,
where [a]⁺=max{a, 0}. If one may route flow xᵢⱼ^{k} from i to j via the two segment path i-k and k-j then the amount of primary traffic P(e) on link e will be:

P(e)=[(e)+(e)]xᵢⱼ^{k}.

The amount of restoration traffic on link e due to failure F due to the flow xᵢⱼ^{k} may be:

R(e,F)=[Δᵢₖ(e,F)+Δₖⱼ(e,F)]xᵢⱼ^{k}.

One may now formulate the problem of maximizing throughput when the routing uses ECMP and the network may be subjected to SRLG failures as the following linear programming problem:

$$\begin{matrix}max λ \\ {\sum }_{( ijk )} [ ( e ) + ( e ) ] {x}_{ij}^{k} + {\sum }_{( ijk )} [ {Δ}_{ik} ( e , F ) + {Δ}_{kj} ( e , F ) ] {x}_{ij}^{k} \leq c ( e ) ∀ F \text{∀} e & ( 6 ) \\ {\sum }_{k} {x}_{ij}^{k} \geq λ {t}_{ij} \text{∀} ( i , j ) \\ {x}_{ij}^{k} \geq \text{∀} ( i , j , k ) & ( 7 )\end{matrix}$$

Note that that the values of Δᵢⱼ(e,F) only depends on the network topology, link IGP metric and whether ECMP may be used. These values may be precomputed. As in the single link failure case, if one may associate dual multipliers π(e,F) with the constraints (1) and θᵢⱼ with constraints (2) one may write the dual to the linear programming problem:

$$min {\sum }_{e} c ( e ) {\sum }_{f} π ( e , f )$$

$${\sum }_{e} ( e ) {\sum }_{F} π ( e , F ) + {\sum }_{F} {\sum }_{e} {Δ}_{ik} ( e , F ) π ( e , F ) + {\sum }_{e} ( e ) {\sum }_{F} π ( e , F ) + {\sum }_{F} {\sum }_{e} {Δ}_{kj} ( e , F ) π ( e , F ) \leq {θ}_{ij} ∀ k$$

$${\sum }_{ij} {t}_{ij} {θ}_{ij} = 1$$

$$π ( e , f ) \geq 0 \text{∀} e , F$$

$${θ}_{ij} \geq 0 , j$$

For a given set of π(e,f) values, one may set:

$${𝓁}_{ij} = {\sum }_{e} ( e ) {\sum }_{F} π ( e , F ) + {\sum }_{F} {\sum }_{e} {Δ}_{ij} ( e , F ) π ( e , F ) .$$

One may set:

$${θ}_{ij} = {min}_{k} {𝓁}_{ik} + {𝓁}_{kj} \text{∀} ( ij )$$

as in the single link failure case. The rest of the algorithm follows the same pattern as the algorithm for single link failure. The only difference may be in the running time to compute the best intermediate node. The running time in the SRLG failure case, also depends on the number of elements in the set F in addition to the network size.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor may be explicitly shown.

Although the various exemplary embodiments have been described in detail with particular reference to certain exemplary aspects thereof, it should be understood that the invention may be capable of other embodiments and its details are capable of modifications in various obvious respects. As may be readily apparent to those skilled in the art, variations and modifications may be affected while remaining within the spirit and scope of the invention. Accordingly, the foregoing disclosure, description, and figures are for illustrative purposes only and do not in any way limit the invention, which may be defined only by the claims.

What is claimed is:

1. A method of routing a total amount of traffic, tᵢⱼ from a source node i, to a destination node j, the method comprising:
setting an amount of traffic in one iteration;
finding a length for each link e between source node i and destination node j;
finding a best intermediate node k; and
sending a flow from source node i, to destination node j through intermediate node k.

2. The method of claim 1, further comprising:
setting the amount of traffic routed in the iteration to t′=tᵢⱼ; and
finding a length lᵢⱼ(e) for each link e based on the current dual variable π(e,f) according to lᵢⱼ(e)=Σ_{f}π(e,f)+Σ_{f∈N}_{ᵢⱼ}₍ₑ₎ π(f,e), where f is a link on a shortest path from i to k which fails.

3. The method of claim 2, further comprising:
finding the best intermediate node k according to:
$${θ}_{ij} = {min}_{k} {\sum }_{e ∈ {S}_{ik}} {𝓁}_{ik} ( e ) + {\sum }_{e ∈ {S}_{kj}} {𝓁}_{kj} ( e ) ,$$
where Sᵢₖ denotes the set of links on the shortest path from i to k, and Sₖⱼ denotes the set of links on the shortest path from k to j.

4. The method of claim 3, further comprising:
finding the minimum capacity link in Sᵢₖ∪Sₖⱼ and setting
$$m = {min}_{e ∈ {S}_{ik} ⋃ {S}_{kj}} c ( e ) .$$

5. The method of claim 4, further comprising:
sending a flow of Δ=min{m,t′} from i to j through k; and
setting xᵢⱼ^{k}←xᵢⱼ^{k}+Δ, where xᵢⱼ^{k} denotes the amount of traffic between i and j that may be routed through node k.

6. The method of claim 5, further comprising:
updating the dual values:
$$π ( e , f ) ← π ( e , f ) [ 1 + ɛ \frac{Δ}{c ( e )} ] ∀ f ∀ e ∈ {P}_{ij} ;$$
$$π ( f , e ) ← π ( f , e ) [ 1 + ɛ \frac{Δ}{c ( f )} ] ∀ f ∈ {N}_{ij} ( e ) ∀ e ∈ {P}_{ij} ;$$
where Pᵢⱼ=Sᵢₖ∪Sₖⱼ denote links in the two segments that are used for the routing flow, and e denotes capacity.

7. The method of claim 6, further comprising:
setting t′←t′−Δ.

8. The method of claim 7, further comprising:
running multiple iterations until the total traffic tᵢⱼ is routed.

9. A routing device used for routing a total amount of traffic, tᵢⱼ from a source node i, to a destination node j, the device comprising
a memory; and
a processor configured to:
set an amount of traffic in one iteration;
find a length for each link e between source node i and destination node j;
find a best intermediate node k; and
send a flow from source node i, to destination node j through intermediate node k.

10. The device of claim 9, wherein the processor is configured to:
set the amount of traffic routed in the iteration to t′=tᵢⱼ; and
find a length lᵢⱼ(e) for each link e based on the current dual variable π(e,f) according to lᵢⱼ(e)=Σ_{f}π(e,f)+Σ_{f∈N}_{ᵢⱼ}₍ₑ₎ π(f,e), where f is a link on a shortest path from i to k which fails.

11. The device of claim 10, wherein the processor is configured to:
find the best intermediate node k according to:
$${θ}_{ij} = {min}_{k} {\sum }_{e ∈ {S}_{ik}} {𝓁}_{ik} ( e ) + {\sum }_{e ∈ {S}_{kj}} {𝓁}_{kj} ( e ) ,$$
where Sᵢₖ denotes the set of links on the shortest path from i to k, and Sₖⱼ denotes the set of links on the shortest path from k to j.

12. The device of claim 11, wherein the processor is configured to:
find the minimum capacity link in Sᵢₖ∪Sₖⱼ and set
$$m = {min}_{e ∈ {S}_{ik} ⋃ {S}_{kj}} c ( e ) .$$

13. The device of claim 12, wherein the processor is configured to:
send a flow of Δ=min{m,t′} from i to j through k; and
set xᵢⱼ^{k}←xᵢⱼ^{k}+Δ, where xᵢⱼ^{k} denotes the amount of traffic between i and j that may be routed through node k.

14. The device of claim 13, wherein die processor is configured to:
update the dual values:
$$π ( e , f ) ← π ( e , f ) [ 1 + ɛ \frac{Δ}{c ( e )} ] ∀ f ∀ e ∈ {P}_{ij} ;$$
$$π ( f , e ) ← π ( f , e ) [ 1 + ɛ \frac{Δ}{c ( f )} ] ∀ f ∈ {N}_{ij} ( e ) ∀ e ∈ {P}_{ij} ;$$
where Pᵢⱼ=Sᵢₖ∪Sₖⱼ denote links in the two segments that are used for the routing flow, and e denotes capacity.

15. The device of claim 14, wherein the processor is configured to:
set t′←t′−Δ.

16. The device of claim 15, wherein the processor is configured to:
run multiple iterations until the total traffic tᵢⱼ is routed.

17. A non-transitory computer readable storage device, storing program instructions that when executed cause an executing device to perform a method of routing a total amount of traffic, tᵢⱼ from a source node i, to a destination node j, the method comprising:
setting an amount of traffic in one iteration;
finding a length for each link e between source node i and destination node j;
finding a best intermediate node k; and
sending a flow from source node i, to destination node j through intermediate node k.

18. The non-transitory computer readable storage device of claim 17, wherein the method further comprises:
setting the amount of traffic routed in the iteration to t′=tᵢⱼ; and
finding a length lᵢⱼ(e) for each link e based on the current dual variable π(e,f) according to lᵢⱼ(e)=Σ_{f} π(e,f)+Σ_{f∈N}_{ᵢⱼ}₍ₑ₎ π(f,e), where f is a link on a shortest path from i to k which fails.

19. The non-transitory computer readable storage device of claim 18, wherein the method further comprises:
finding the best intermediate node k according to:
$${θ}_{ij} = {min}_{k} {\sum }_{e ∈ {S}_{ik}}^{ } {𝓁}_{ik} ( e ) + {\sum }_{e ∈ {S}_{kj}} {𝓁}_{kj} ( e ) ,$$
where Sᵢₖ denotes the set of links tin the shortest path from i to k, and Sₖⱼ denotes the set of links on the shortest path from k to j.

20. The non-transitory computer readable storage device of claim 19, wherein the method further comprises:
finding the minimum capacity link in Sᵢₖ∪Sₖⱼ and setting
$$m = {min}_{e ∈ {S}_{ik} ⋃ {S}_{kj}} c ( e ) .$$
